(19) United States
(12) Patent Application Publication
(10) Pub. No.: US 2003/0047577 A1
(43) Pub. Date: Mar. 13, 2003

(54) General-purpose bag to be used in a motor vehicle

(76) Inventor: Hans Christian Seifert, Durbach (DE)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 10/148,642

(22) PCT Filed: Nov. 30, 2000
(86) PCT No.: PCT/EP00/12014

(30) Foreign Application Priority Data
Dec. 1, 1999 (DE) 29921171.1

(51) Int. Cl. B60R 7/00; B60R 9/00; B60R 11/00; B60R 7/06

(52) U.S. Cl. 224/482; 224/275; 224/483

(57) ABSTRACT

A general purpose bag to be used in a motor vehicle. The bag serves for receiving small objects, especially small waste, in motor vehicles. The bag includes at least one fixing element that is connected to a gear shift lever, a window crank or a holding projection that can be used to affix the bag.

### BACKGROUND

This invention pertains to an all-purpose vehicle bag in which to keep small objects, in particular small trash inside a vehicle, in which the all-purpose vehicle bag includes at least one fastening element for fastening the all-purpose bag on the stick shift, a window roll-down handle or a similar projection, and in which the all-purpose bag is formed essentially of two overlapping material layers, that are connected together along the edge of at least one material layer up to an inlet.

A problem that occurs frequently in vehicles is where to stow handkerchiefs, sunglasses or other objects within reach of the driver, especially when the vehicle being used has no place to store them, or has one that is inadequate, or if the existing storage is unsuitable for the intended purpose.

During a trip in a vehicle, it is frequently desired to keep smaller items and consumables, in particular trash that is generated during the trip, near the driver or passenger. Frequently the storage space located inside the vehicle is not sufficient for these small objects, especially if the ashtray does not have any additional space and other storage spaces are already full with maps, windshield scrapers and other take-along items.

In order to collect trash, preferably during the trip, and to remove it from the vehicle interior afterwards without a lot of mess, many drivers bring along small trash containers. These containers have a cover with which to close them. However, these kinds of trash containers are hard to place near the driver for use during a trip. In addition, there is the danger that these trash containers will move around in an uncontrolled manner inside the vehicle during the trip, and thus endanger the safety in the vehicle.

From U.S. Pat. No. 5,246,190, it is known to provide a store-type plastic bag as an all-purpose vehicle bag. To hold the bag, a mounting clip is provided that can be attached, for example, to the door of the glove compartment. On the mounting clip, two spaced apart hooks are provided on which the plastic bag can be hung by its flexible handles.

Because the plastic bag is hung on the spaced apart hooks, the bag is stretched in the are of its inlet, so that the inlet is not accessible. Placing things in the bag is therefore more difficult, since the bag is hung on both sides of the inlet opening, and the inlet must be opened prior to placing things in the bag.

### SUMMARY

Thus, the object is to create an all-purpose vehicle bag in which to keep small objects, in particular small trash, inside the vehicle. This bag is to be easy to reach and handle for the vehicle occupants, in particular the driver, during a trip, without vehicle safety being endangered.

The solution to this object according to the invention lies in:

part of one material layer extends beyond the other material layer and extends above the inlet and includes a fastening element, which part includes a punched-out through opening for the stick shift, window roll-down handle or similar projection

or that the all-purpose vehicle bag includes two flexible strips that can be tied together as the fastening element.

If the fastening element is formed in the part that extends above the bag inlet or is provided on that part, the inventive all-purpose vehicle bag can be place in various types of vehicles without any additional holders, and the inlet is well held in an easily accessible position for the vehicle users. The inventive all-purpose vehicle bag also is held with the inlet wide open and is safely and securely held in the vehicle on the shift handle or on another holding point when two flexible strips that can be tied together are provided as the fastening element on the all-purpose vehicle bag.

It is also advantageous when the material strips that can be tied together are formed as one piece with the material for the all-purpose vehicle bag

This allows the all-purpose vehicle bag according to the invention to be temporarily fixed to the stick shift or to a window roll-down handle easily, thus being located within reach of the vehicle occupants without fear of the all-purpose vehicle bag moving from its selected position and about the vehicle interior uncontrollably. Since the all-purpose vehicle bag according to the invention is specially designed to be fastened to vehicle projections for holding, in particular to the stick shift, it and its contents can be removed from inside the vehicle in one motion as needed.

If the all-purpose vehicle bag is to be disposed of after use together with its contained trash, for example, it is advantageous if the all-purpose vehicle bag and the fastener (at least one) are made of a recyclable material, in particular paper and/or plastic.

The expense in manufacturing the all-purpose vehicle bag according to the invention is reduced further by designing the container as a foil bag.

An embodiment is preferred in which the overlapping material layers used to form the all-purpose vehicle bag are welded or glued together in the edge area of at least one material layer. Such an all-purpose vehicle bag that can be formed from overlapping material layers formed from one material piece or also from more material pieces, or merely at least two overlapping and connected together material layers, can be simply and cheaply produced.

### BRIEF DESCRIPTION OF THE DRAWINGS

Other features of the invention can be found in the following description of a preferred embodiment according to the invention, in conjunction with the claims and the drawing. The individual features can be implemented alone or in combination in any embodiment according to the invention.

Shown in a schematic representation are:

FIG. 1 is a view of an all-purpose vehicle bag designed as a foil bag in which to keep small objects, wherein one part that serves as a fastener and that extends beyond the inlet includes a through hole.

FIG. 2 is a view of the all-purpose vehicle bag from FIG. 1 in its position of use fixed to the stick shift of a vehicle.

FIG. 3 is a view of an all-purpose vehicle bag with a loop fastener having two material strips that can be tied together as the fastening element.

### DETAILED DESCRIPTION OF THE PREFERRED EMBODIMENTS

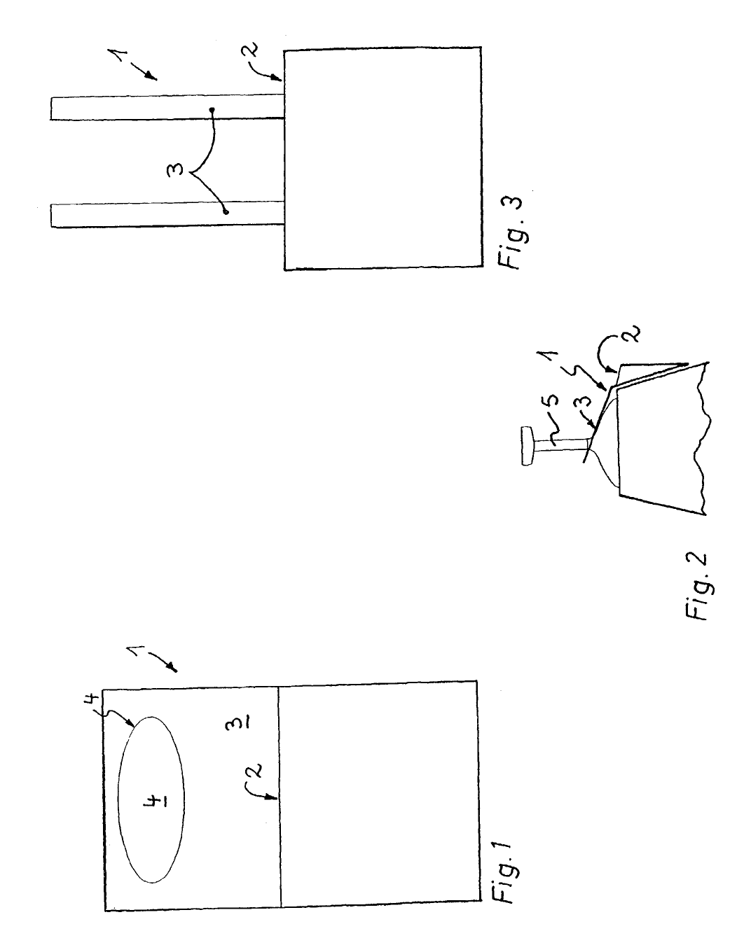

In FIGS. 1 through 3, an all-purpose vehicle bag 1 is shown in various embodiments. It is used to keep small objects, in particular small trash inside a vehicle.

The all-purpose vehicle bag 1 is designed here as a foil bag. It has two rectangular material layers whose adjacent edges are welded, glued or otherwise connected together in a sealed manner up to an inlet 2.

In order to affix the all-purpose vehicle bag 1 near the driver, preferably to the stick shift 5, each of the all-purpose vehicle bags 1 shown in FIGS. 1 through 3 has at least one fastener 3.

One part of the all-purpose vehicle bag 1 according to FIGS. 1 and 2 extends beyond the inlet 2 and serves as a fastener 3. This part has a fastener opening 4 to insert over the stick shift, window roll-down handle or similar projection.

According to FIG. 3, material strip attached to the all-purpose vehicle bag 1 is used as the fastener 3, with the strip being glued, welded or similarly held in place at the ends of the strips to the exterior or interior of one of the two material layers and forming the through hole 4.

In contrast, the all-purpose vehicle bag 1 according to FIG. 3 has two material strips that serve as the fasteners 3, which are formed of flexible material and which can be tied together at the window roll-down handle or similar projection, forming a through hole 4 at the stick shift.

If necessary, the material strips shown in FIGS. 3 and 4 serving as fasteners can also be formed in one piece on the adjacent material layer. In order to be able to manufacture the all-purpose vehicle bag 1 shown here as cost-effectively as possible, it can be advantageous if these all-purpose vehicle bags and the fasteners 3 attached to them are made of a single piece of material. Each of these all-purpose vehicle bags 1 can be used to collect trash in particular, wherein the all-purpose vehicle bag 1 and its contained trash can be disposed of easily, in particular if these all-purpose vehicle bags and fasteners 3 attached to them are made of paper, plastic or similar recyclable material.

1. An all-purpose vehicle bag (1) in which to keep small objects comprising at least one fastener (3) to fasten the all-purpose vehicle bag (1) to a stick shift (5) of a window roll-down handle or similar projection, and in which the all-purpose bag (1) is formed of two overlapping material layers, that are connected together along an edge of at least one material layer up to an inlet (2), wherein
part of one material layer extends beyond the other material layer and extends above the inlet (2) and includes a fastening element (3), the part includes a punched-out through opening (4) for the stick shift (5), the window roll-down handle or the similar projection,
or that the all-purpose vehicle bag (1) includes two flexible strips that can be tied together as the fastening element (3).

2. An all-purpose vehicle bag according to claim 1, characterized in that the all-purpose vehicle bag (1) and preferably the fastening element (3) is made of a recyclable material, in particular paper and/or plastic.

3. An all-purpose vehicle bag according to claim 1, characterized in that the all-purpose vehicle bag (1) is a foil bag.

4. An all-purpose vehicle bag according to claim 1, characterized in that the overlapping material layers are welded or glued along the edge of at least one of the material layers.
